(19) United States
(12) Patent Application Publication
(10) Pub. No.: US 2025/0096610 A1
(43) Pub. Date: Mar. 20, 2025

(54) WIRELESS BLUETOOTH CHARGING DEVICE

(71) Applicant: Pierre Stockton, Round Rock, TX (US)

(72) Inventor: Pierre Stockton, Round Rock, TX (US)

(21) Appl. No.: 18/426,203

(22) Filed: Jan. 29, 2024

Related U.S. Application Data
(60) Provisional application No. 63/539,483, filed on Sep. 20, 2023.

(51) Int. Cl. H02J 50/20; H02J 7/00

(52) U.S. Cl. CPC H02J 50/20; H02J 7/00034; H02J 7/0049; H02J 7/0029; H02J 2207/20

(57) ABSTRACT

A wireless Bluetooth charging device for wirelessly charging a digital device that has a Bluetooth connecting feature comprising a module housing a transformer to step down the voltage to a desired level and a bridge rectifier to convert the AC to DC, a capacitor to store and smooth the voltage output, a regulator to get exact DC voltage output. The module further comprises a set of charging pins, an LED indicator light and a sync button to turn on the Bluetooth charging option on the other side.

### CROSS-REFERENCE TO RELATED APPLICATIONS

This application is a continuation of U.S. Provisional Application No. 63/539,483, filed on Sep. 20, 2023, which is hereby incorporated by reference in its entirety.

### BACKGROUND

### 1. Field of the Invention

The present invention relates generally to charging devices, and more specifically to a wireless Bluetooth charging device.

### 2. Description of Related Art

A battery charger, recharger, or simply charger, is a device that stores energy in a battery by running an electric current through it. The charging protocol (how much voltage or current for how long, and what to do when charging is complete) depends on the size and type of the battery being charged.

A simple charger works by supplying a constant DC or pulsed DC power source to a battery being charged. A simple charger typically does not reach long distances and is limited in use by the length of the wire connecting the charger to the digital device. Even so, many batteries left on a simple charger for too long will be weakened or destroyed due to over-charging. These chargers also vary in that they can supply either a constant voltage or a constant current, to the battery.

Bluetooth is a short-range wireless technology standard that is used for exchanging data between fixed and mobile devices over short distances and building personal area networks (PANs).

It is an objective of the present invention to provide a wireless Bluetooth charging device used for charging a digital device without being in a wired connection to the charger.

Accordingly, although great strides have been made in the area of charging devices, many shortcomings remain.

### DESCRIPTION OF THE DRAWINGS

The novel features believed characteristic of the embodiments of the present application is outlined in the appended claims. However, the embodiments themselves, as well as a preferred mode of use, and further objectives and advantages thereof, will best be understood by reference to the following detailed description when read in conjunction with the accompanying drawings, wherein:

FIG. 1 is a front view of the wireless Bluetooth charging device of the present invention;

FIG. 2 is a front perspective view of the wireless Bluetooth charging device of FIG. 1;

FIG. 3 is a side perspective view of the wireless Bluetooth charging device of FIG. 1; and

FIG. 4 is a method of use of the wireless Bluetooth charging device of the present invention.

While the wireless Bluetooth charging device and method of use of the present application is susceptible to various modifications and alternative forms, specific embodiments thereof have been shown byway of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the wireless Bluetooth charging device and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The wireless Bluetooth charging device and method of use will be understood, both as to its structure and operation, from the accompanying drawings, taken in conjunction with the accompanying description. Several embodiments of the device are presented herein. It should be understood that various components, parts, and features of the different embodiments may be combined and/or interchanged with one another, all of which are within the scope of the present application, even though not all variations and particular embodiments are shown in the drawings. It should also be understood that the mixing and matching of features, elements, and/or functions between various embodiments are expressly contemplated herein so that one of ordinary skill in the art would appreciate from this disclosure that the features, elements, and/or functions of one embodiment may be incorporated into another embodiment as appropriate unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

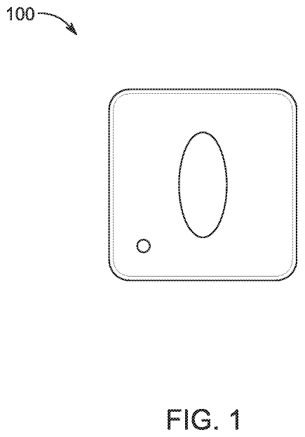

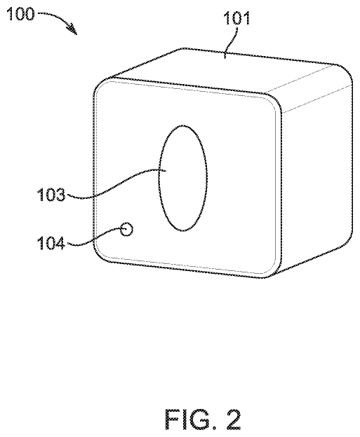

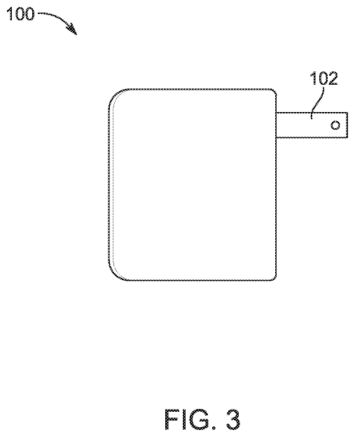

Referring now to the drawings wherein reference characters identify corresponding or similar elements throughout the several views, FIGS. 1-4 depict a wireless Bluetooth charging device 100 and its method of use in accordance with a preferred embodiment of the present application. It will be appreciated that the wireless Bluetooth charging device 100 overcomes one or more of the above-listed problems commonly associated with conventional charging devices. In addition, it should be appreciated that more or fewer such components may be included in different embodiments of the wireless Bluetooth charging device 100.

In the contemplated embodiment as illustrated in FIGS. 1-3, a wireless Bluetooth charging device 100 comprises a module 101 housing a transformer to step down the voltage to a desired level and a bridge rectifier to convert the AC to DC, a capacitor to store and smooth the voltage output, a regulator to get exact DC voltage output. The module 101 further includes a set of charging pins 102 to be in contact with the AC power supply on one side, an LED indicator light 103, and a sync button 104 to turn on the Bluetooth charging option on the other side.

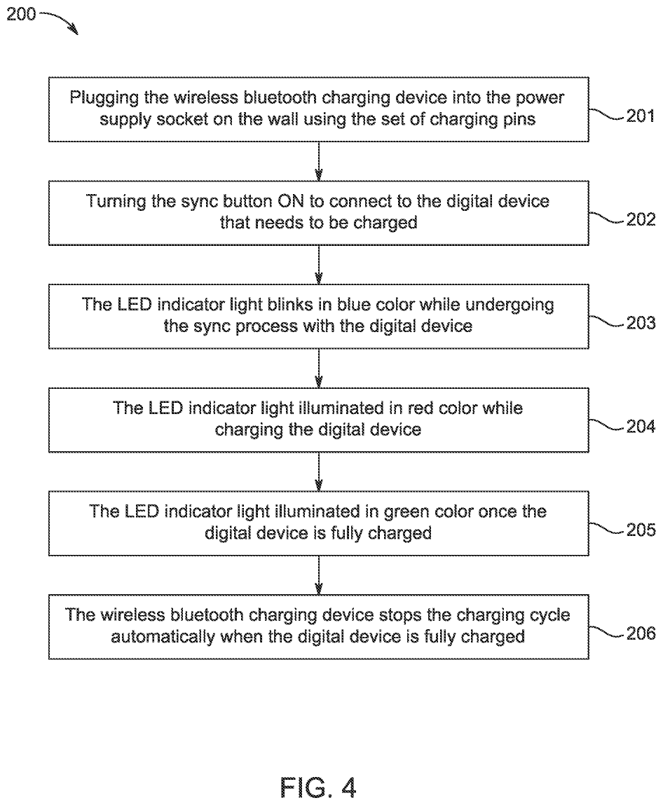

In the contemplated embodiment, as illustrated in FIG. 4, the method of use 200 of the wireless Bluetooth charging device 100 for charging a digital device located within 50 feet distance of the wireless Bluetooth charging device 100 includes the steps of plugging the charging device into the power supply socket on the wall using the set of charging pins 102 as shown with box 201. Turning the sync button 104 ON to connect to the digital device that needs to be charged as shown with box 202. The LED indicator light blinks in blue color while undergoing the sync process with the digital device as shown with box 203, is illuminated in red color while charging the digital device as shown with box 204, and is illuminated in green color once the digital device is fully charged as shown with box 205 and stops the charging cycle automatically when the digital device is fully charged as shown with box 206.

In the contemplated embodiment, the wireless Bluetooth charging device 100 is in a cube or cuboid shape, preferably 2 inches wide and 4 inches long, made of any suitable material including but not limited to plastic or a blend of plastic, with the set of charging pins 102 made out of suitable metal including but not limited to stainless steel.

In the contemplated embodiment, the wireless Bluetooth charging device 100 is configured to be used with any digital device that connects with Bluetooth technology and is configured to be used by any person of any age with any power supply of alternate current.

In the contemplated embodiment, the wireless Bluetooth charging device 100 of the present invention is configured to provide output over-current and over-voltage protection, input over-current and over-voltage protection, high-temperature shutdown, short-circuit protection, and electrostatic discharge (ESD) protection.

In the contemplated embodiment, the wireless Bluetooth charging device 100 of the present invention is configured to be compatible with any kind of digital device using Bluetooth technology including but not limited to smartphones such as iPhones, Android phones such as Samsung, Google, Microsoft, Sony, HTC, LG, etc.

It should be appreciated that the wireless Bluetooth charging device 100 described in the present application is a lightweight and portable wireless charging device to be used to charge any digital device using Bluetooth technology.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as outlined in the description. Although the present embodiments are shown above, they are not limited to just these embodiments, but are amenable to various changes and modifications without departing from the spirit thereof.

What is claimed is:

1. A wireless Bluetooth charging device for wirelessly charging a digital device comprising:
a module housing a transformer to step down the voltage to a desired level and a bridge rectifier to convert the AC to DC, a capacitor to store and smooth the voltage output, a regulator to get exact DC voltage output;
the module further comprising:
a set of charging pins to be in contact with the AC power supply on one side;
an LED indicator light illuminating in blue color during the sync process of the wireless Bluetooth charging device with the digital device, illuminating in red color during the wirelessly charging of the digital device, and in green color once the battery of the digital device is completely charged; and
a sync button to turn on the Bluetooth charging option on the other side;
wherein the wireless Bluetooth charging device can be used to charge a digital device that has a Bluetooth connecting feature.
